(19) United States
(12) Patent Application Publication
(10) Pub. No.: US 2020/0154942 A1
(43) Pub. Date: May 21, 2020

(54) System and Method for Preparing Food

(71) Applicant: Vorwerk & Co. Interholding GmbH, Wuppertal (DE)

(72) Inventors: Christian Büttner, Stuttgart (DE); Hendrik Koetz, Wetter (DE); Michael Sickert, Ennepetal (DE); Stefan Rest, Wollerau (CH); Marcelo Caballero, Wadenswil (CH)

(21) Appl. No.: 16/681,229

(22) Filed: Nov. 12, 2019

(30) Foreign Application Priority Data
Nov. 15, 2018 (DE) 10 2018 128 688.0

(51) Int. Cl. A47J 36/32; G05B 15/02

(52) U.S. Cl. CPC A47J 36/32; G05B 15/02

(57) ABSTRACT

To improve food preparation and make it more reliable, this invention proposes a food preparation system comprising a first kitchen appliance, a second kitchen appliance and a control unit, the first kitchen appliance comprising at least one detection means for detecting at least one piece of information relating to a property of a food, wherein the control unit is connected via a first communication connection to the first kitchen appliance, and wherein the control unit is connected to the second kitchen appliance via a second communication connection, characterized in that the control unit is configured to select at least one preparation instruction in dependence on the at least one piece of detected information, and in that the second kitchen appliance is configured to perform a preparation operation in accordance with the at least one selected preparation instruction. Furthermore, the present invention provides a corresponding method.

### CROSS-REFERENCE TO RELATED APPLICATION

This application claims priority to German Patent Application No. 10 2018 128 688.0 filed Nov. 15, 2018, the disclosure of which is hereby incorporated by reference in its entirety.

### BACKGROUND OF THE INVENTION

### Field of the Invention

The present invention concerns a food preparation system comprising a first kitchen appliance, a second kitchen appliance and a control unit, wherein the first kitchen appliance comprises at least one detection means for detecting at least one information about a property of a food, wherein the control unit is connected to the first kitchen appliance via a first communication connection and wherein the control unit is connected to the second kitchen appliance via a second communication connection. Furthermore, the present invention concerns a process for the preparation of food.

### Description of Related Art

At present, databases for cooking recipes are known, which are accessible, for example, via the Internet. The recipes stored in the database usually contain definite preparation instructions and quantities or types of ingredients which are used to achieve a successful preparation result.

In order to find a suitable recipe, it is also known, for example, to enter a number of persons or a type of food as search criteria. The result of such a search often turns out to be inaccurate, especially with regard to the properties of foods to be used for the selected recipe. Furthermore, it can happen that a user is not familiar with special properties of food, so that errors can occur already during the input of search criteria.

Furthermore, foods of the same type have different characteristics for natural reasons. As a concrete example, for two apples it cannot be assumed that the apples are exactly the same.

This creates the difficulty of complying with a standardized preparation instruction, for example in the form of a recipe.

The present invention is therefore based on the problem of improving the preparation of food and making it more reliable.

### SUMMARY OF THE INVENTION

According to a first teaching, this problem is solved according to the invention by a system for preparing food, comprising a first kitchen appliance, a second kitchen appliance and a control unit, wherein the first kitchen appliance comprises at least one detection means for detecting at least one information about a characteristic of a food, wherein the control unit is connected to the first kitchen appliance via a first communication connection and wherein the control unit is connected to the second kitchen appliance via a second communication connection, characterized in that the control unit is arranged to select at least one preparation instruction in dependence on the at least one detected information, and in that the second kitchen appliance is arranged to perform a preparation operation in accordance with said at least one selected preparation instruction.

This allows the presence of a food to be detected and automatically taken into account as a search criterion when selecting a preparation instruction, making it easier to select a preparation instruction.

In addition, actual properties of existing foods can be captured and taken into account when selecting a preparation instruction. This increases the probability of achieving a successful preparation result on the one hand and reduces the time required to find a suitable preparation instruction on the other.

This will also allow a user to be presented with a selection of suitable preparation instructions for existing foods so that he can select a preparation instruction and, if necessary, a preparation process according to the selected preparation instruction can be carried out by the second kitchen appliance.

According to a second teaching of the present invention, the above-mentioned problem is also solved by a corresponding method of food preparation, in which at least one piece of information on the properties of a food is detected by a first kitchen appliance, in which a preparation instruction is selected according to the at least one piece of detected information, and in which a preparation process is carried out by the second kitchen appliance according to the at least one selected preparation instruction.

The procedure corresponds to controlling a system according to the first teaching, so that the procedure achieves the same advantages as for the system.

The term “food preparation” refers to an intentional change in the state of a food and all actions necessary for this, such as for instance heating, cooking, steam cooking, cutting, crushing, mixing, stirring as well as weighing, volume measurement, recognition of a degree of browning or crispness and others.

The term kitchen appliance refers to appliances which are configured to change the condition of a food. This includes, for example, equipment that changes the state of a food from a raw state to a state ready for consumption, such as cooking or baking.

The first kitchen appliance and the second kitchen appliance may have other elements that directly or indirectly contribute to changing the condition of a food, such as for instance a moisture device for supplying water vapour. This can change the consistency of a food, such as when preparing bread dough.

The term kitchen appliance refers in particular to appliances intended for private use in a household.

A baking oven or a microwave oven with a heating element is preferably used as the first kitchen appliance. The second kitchen appliance is preferably configured as a cook mixer with a shredding or mixing device which is configured for shredding or mixing food. The first kitchen appliance and the second kitchen appliance each preferably have a housing, a control module and a power supply unit.

The system has a control unit. The control unit preferably has a data memory, a microprocessor and a communication module, whereby computer algorithms stored in the data memory can be executed by the microprocessor. Commands resulting from such execution can then be transmitted by the communication module to other devices, such as the first kitchen appliance or the second kitchen appliance.

The control unit is connected to the first kitchen appliance via a first communication connection and to the second kitchen appliance via a second communication connection. The first communication connection and the second communication connection can be a cable connection or a wireless connection. A wireless connection, for example, can be based on a commonly used protocol such as Bluetooth, infrared or WLAN (wireless local area network). Any conversion of signals required for this can be carried out by the control unit.

Furthermore, information on the condition of a food and commands to be executed by the first kitchen appliance or by the second kitchen appliance can preferably be transmitted via the first communication connection and via the second communication connection. Furthermore, both communication connections can be transmitted in the direction of the control unit and from the control unit.

The first kitchen appliance has at least one detection means for detecting at least one piece of information about the condition of a food. The detection means can be designed in different ways, for example as an optical sensor, thermometer, balance, stopwatch or as a sensor for a torque. The first kitchen appliance may have a single means of detection or several means of detection at the same time.

The at least one means of detection may be located outside the housing of the first kitchen appliance or inside the housing of the first kitchen appliance, depending on the information to be detected. If, for example, the temperature of a food is measured, then a thermometer is preferably arranged in the first kitchen appliance. For example, a humidity sensor can also be mounted on an exterior wall of the first kitchen appliance if room humidity is to be measured. This can be used, for example, to determine the moisture content of ingredients.

The condition of a food may be defined by properties of different types which may be relevant depending on the intended preparation process, such as weight, volume, mixing ratio of different ingredients, quantity or number, viscosity, moisture content, degree of browning, colour, acidity or other.

The at least one piece of information detected shall preferably correspond to an actual value expressed in such a way as to be comparable with another piece of information of the same kind. If, for example, information about a moisture content is detected, this can be a relative value expressed as a percentage.

The at least one information entered can result indirectly from the detection. For example, an optical sensor can be used to capture an image of food. The image can then be evaluated by comparing detected shapes, colors and light intensities of the image with predefined reference values for shapes, colors and light intensities, wherein the reference values are associated with food types and estimated food weights. From the comparison, a type of food can be determined and, if necessary, a food weight can be estimated.

In addition, at least one detection means can, after selection of a preparation instruction, be used to detect further information, which can then be used to check whether all the ingredients or foods required for the preparation instruction are available in sufficient quantities.

The preparation instruction is, in particular, at least one preparation parameter or set point relating to a preparation operation or to an achieved state of the food. Such a preparation parameter can be given for one of the following variables: air temperature, baking time, resting time, information about a time at which a preparation process is to begin or end, distance to a heating element, height for a food carrier, humidity, internal food temperature, external food temperature, food shaping, food moisture, degree of browning, food weight, food volume, packing density of food units on a food carrier or other.

The preparation instruction preferably has at least two preparation instruction variants, whereby these variants differ in terms of, for example, ingredient quantities or ingredient types. There may be several variants of a preparation instruction for preparing a loaf of bread. In a first variant, a quantity M of a glucose-containing flour can be specified; in a second variant, a quantity M of a glucose-free flour can be specified; and in a third variant, a quantity P of the glucose-containing flour different from the quantity M can be specified. Depending on the variant, the preparation of a medium-size bread containing glucose, a medium-size bread free of glucose or a small bread containing glucose is achieved.

A preparation instruction preferably corresponds to at least one preparation directive of a recipe. Such a preparation directive can, for example, correspond to cooking temperatures that are to be observed for successive cooking times, a rest period, a mixture of ingredients, a weight, a volume or other.

Alternatively or in addition, the preparation instructions may contain at least one piece of information relating to a characteristic of the first kitchen appliance and/or the second kitchen appliance. Such a property may be, for example, a holding capacity, a predictable wear, a recommended maximum operating temperature or a tare weight for comparison with a detected weight information. Such a characteristic is preferably inherent in the kitchen appliance concerned and is preferably predetermined in advance by the designer.

Preferably at least one preparation instruction is stored at least temporarily in the data memory of the control unit.

The control unit is set up to select at least one preparation instruction depending on the at least one information detected. For this purpose, the control unit may compare the detected information with a preparation parameter of at least one preparation instruction, where the preparation parameter concerns the same property of a food as the detected information. From the result of the comparison, the control unit can determine for which preparation instruction the least difference between the information detected and the corresponding preparation parameter results.

In addition, several preparation instructions may be selected if they contain at least one identical indication.

The second kitchen appliance is configured to perform a cooking operation according to at least one selected cooking instruction. For this purpose, preferably the control module of the second kitchen appliance is configured to generate commands, the execution of which causes a reaction of the heating element according to the selected preparation instruction. The totality of these reactions forms a preparation process.

Furthermore, the preparation instructions available for selection preferably contain information on preparation parameters and preparation instructions that can be at least partially carried out by the first kitchen appliance. If, for example, the first kitchen appliance is designed as an oven that can only heat up to a maximum given temperature, then there are only preparation instructions available for selection for which the heating or heating should not exceed this maximum temperature.

Alternatively or additionally, properties of the second kitchen appliance can be used as search criteria for selecting a preparation instruction.

In the following, different embodiments of the system and the method are described, whereby the individual embodiments apply in each case both to the system and to the method. In addition, the individual embodiments can be combined with each other.

According to a first embodiment of the system, the preparation instruction has at least two preparation instruction variants with different quantity specifications, and the control unit is configured to select one of the preparation instruction variants based on the at least one piece of information detected.

Within a corresponding embodiment of the method, a preparation instruction variant of a preparation instruction is selected depending on the at least one piece of information detected.

This way, a variant of a preparation instruction that is suitable for the quantities of food actually available can be automatically selected.

For this purpose, the control unit can, for example, compare detected information with indications of at least one preparation instruction or at least one preparation instruction variant. The result of the comparison can be used to determine for which preparation instruction variant the difference between information detected and indications is the smallest.

If the information detected and indications are expressed as numerical values, the comparison gives a value corresponding to the difference. This value can then be compared with a tolerance range. If the value lies within the tolerance range, the system selects the preparation instruction variant. If the value is outside the tolerance range, the system does not select the preparation instruction variant and, if necessary, displays a message informing you that no appropriate preparation instruction variant could be selected.

In a further embodiment of the system, the control unit is configured to determine a new preparation instruction variant based on the selected preparation instruction.

Within a corresponding embodiment of the method, a new variant of the preparation instruction is determined on the basis of at least one existing variant of the preparation instruction and depending on the at least one piece of information detected.

This enables a preparation instruction or a preparation instruction variant to be adapted to the actual properties of an existing food. This reduces the effort for a user and at the same time the risk, for example when calculating an appropriate amount of ingredients.

Based on the comparison between the information detected and the indications of the preparation instruction or the preparation instruction variants, it can be determined which indications are closest to the information detected. However, a difference, if any, may be too great to allow a selected preparation instruction variant to actually be carried out.

The system and method can be used to change indications in a preparation instruction variant that comes closest to the information detected. Only a single indication or several indications can be changed at the same time.

If, for example, an ingredient quantity indication is to be changed, a mathematical size ratio that exists between ingredient quantity indications for different ingredients of the existing preparation instruction variant can be used to determine new ingredient quantity indications. For example, a preparation instruction variant can exist for a tomato sauce with a quantity X of ingredients for tomatoes and a quantity Y of ingredients for cream, and a quantity Z of ingredients for tomatoes, where Z is less than X, can be detected. Then the relationship between X and Y can be used to calculate a new quantity of ingredients for cream that matches the actual quantity of Z present.

Alternatively or additionally, for example, an indication for a food type can be changed to determine a new preparation instruction variant. For example, the presence and quantities of several foods can be determined. In addition, it is possible to select a preparation instruction that contains only some of these foods as ingredients. A new variant of this preparation instruction can then be determined on the basis of the food actually available, for example by replacing apples with pears to prepare a cake.

According to another embodiment of the system, the existing preparation instruction has at least one indication of a quantity of ingredients and the new preparation instruction variant corresponds to scaling the at least one indication.

Within a corresponding embodiment of the method, the new variant of the preparation instruction is determined by scaling at least one ingredient quantity indication specified by the selected preparation instruction.

This simplifies the calculation of ingredient quantities and thus also the determination of the new preparation instruction variant.

Scaling is the use of a customizable variable, such as a percentage, to determine or calculate new indication. For example, a quantity of food that actually exists can correspond to a percentage of an indication of a preparation instruction variant for a quantity of ingredients for the food. This percentage can then be used to calculate further information on a quantity of ingredients in the preparation instruction.

According to another embodiment of the system, the control unit is configured to select a preparation instruction based on a user input.

Within a corresponding embodiment of the method, at least one preparation instruction is selected depending on a user input.

This way, a preparation instruction can be selected not only on the basis of the properties of existing foods, but also on the basis of a user's individual wishes. In general, this allows additional search criteria to be taken into account when selecting a preparation instruction.

The term user input refers to information that a user enters into the system or the control unit via a user interface. For this purpose, the control unit preferably has a user interface which is designed as a touch screen, keyboard, sound recording device, optical recording device or other. The user interface is preferably connected to the data memory of the control unit. This allows information to be entered via the user interface and stored in the data memory.

A preparation instruction is selected depending on the user input. This is preferably done in the same way as the selection of the preparation instructions depending on the information detected by the first kitchen appliance. Accordingly, the user input is preferably used as a further search criterion for the selection. In particular, the user input can be compared with indications of at least one preparation instruction and the preparation instruction for which the difference is smallest can be selected accordingly.

An example of a user input is a restriction to preparation instructions with specific ingredients. In this way, an allergy sufferer can ensure that only those preparation instructions are selected that correspond to a preparation of food that is safe for him.

As a further example, a number of persons for whom the preparation result should be suitable can be entered by a user and considered as a search criterion.

As a further example, properties of other existing foods can be entered as user input, whereby no information about these foods is captured by the first kitchen appliance. These other existing foods can be for example spices, water, milk or others, where the user knows that these are actually present.

According to another embodiment of the system, the control unit is connected to an external preparation instructions database via a third communication connection and the control unit is configured to select the preparation instructions from the external database.

Within a corresponding embodiment of the method, at least one preparation instruction is selected from an external database.

This will allow access to a greater variety of preparation instructions, where appropriate, thus increasing the number of possibilities to prepare food through the system.

The term database refers to all media on which at least one preparation instruction can be stored digitally, such as a hard disk, a cloud, a server or similar. Furthermore, an external database is preferably understood to be media which are not part of the originally provided data memory of the control unit and which can be connected to the control unit via a communication connection. For example, the following media can be considered: USB sticks, external hard disks, tablets, computers, wearables and computer units in general, Internet, cloud, storage medium of a private network and others.

The third communication connection is preferably wireless and can be based on a commonly used protocol such as Bluetooth, infrared or WLAN (wireless local area network). Any conversion of signals required for this can be carried out by the control unit.

At least one preparation instruction can be selected from an external database. For this purpose, the control unit is preferably configured to retrieve preparation instructions from the external database via the third communication connection and to compare information from these preparation instructions with detected information or user inputs.

The user input can concern information detected by the first kitchen appliance and be used to change the detected information. If, for example, information about a food quantity or a food weight is detected, a smaller quantity of food can be taken into account for the selection of a preparation instruction by entering a user input.

As a concrete example, a weight G of potatoes can be detected and a user input with a weight H of potatoes can be entered, whereby the weight H is smaller than the weight G.

This can be done, for example, if the user wants to use a portion of the potato for further preparation. For example, the weight H rather than the weight G can be considered as a search criterion for selecting a preparation instruction.

According to another embodiment of the system, the first kitchen appliance is configured to perform at least one preparation operation according to at least one selected preparation instruction.

Within a corresponding embodiment of the method, at least one preparation operation shall be carried out by the first kitchen appliance in accordance with at least one selected preparation instruction.

In this way, a preparation instruction can be selected for which a preparation operation must be carried out by the second kitchen appliance and another preparation operation by the first kitchen appliance. As a concrete example, a selected preparation instruction may correspond to the preparation of a marinated piece of meat. First a marinade is to be prepared by the second kitchen appliance and then the marinated piece of meat is to be cooked by the first kitchen appliance.

Furthermore, the second kitchen appliance has detection means for detecting at least one piece of information relating to a characteristic of a food. This information can then be used as search criteria when selecting a preparation instruction.

Further search criteria can also be properties of the first kitchen appliance, so that the preparation instruction can be selected on the basis not only of food properties, but also of the possibilities offered by the first kitchen appliance for a preparation process.

According to another embodiment of the system, the first kitchen appliance, the second kitchen appliance and/or the control unit is configured to display the at least one selected preparation instruction.

Within a corresponding embodiment of the method, the at least one selected preparation instruction is displayed by another kitchen appliance.

This makes it easier for the second kitchen appliance to carry out a cooking operation in accordance with the selected preparation instructions. Furthermore, the user can be made aware, for example, of a too small quantity of ingredients or a too small ingredient weight.

For this purpose, the second kitchen appliance preferably has a display device. The indicating device may, for example, be a screen or a touch-operated indicating device. If several preparation instructions have been selected, they can be displayed simultaneously by the second kitchen appliance.

The display device may also be configured to display at least one piece of detected information.

According to another embodiment of the system, the control unit is integrated in the first kitchen appliance or in the second kitchen appliance.

This makes it easier to design the system. This can further increase customer loyalty by requiring the presence of the cook mixer for optimal control of the kitchen appliance.

The term integration refers to the arrangement of the control unit on or in the housing of the first kitchen appliance or the second kitchen appliance.

According to another embodiment of the system, the control unit has at least one detection means for detecting at least one piece of information relating to a characteristic of a food and is configured to select a preparation instruction depending on the at least one piece of information detected by the detection means of the control unit.

Within a corresponding embodiment of the method, at least one piece of information on a property of a food is detected by the control unit and a preparation instruction is selected depending on the at least one piece of information detected by the control unit.

This allows information on food to be detected which, for example, cannot be detected by the first kitchen appliance due to the size or nature of the food. Furthermore, information can be captured quickly and easily, especially if the control unit is designed as a mobile device.

Preferably for this system the control unit is located outside the housing of one of the kitchen appliances.

The at least one detection means of the control unit may be of a similar or different nature as a detection means of the first kitchen appliance. For example, a detection means of the first kitchen appliance may be designed as a weighing module and a detection means of the control unit may be designed as an optical sensor.

For example, the first kitchen appliance can be designed as an oven and the control unit as a tablet with a camera. This allows a brighter image of a food product to be detected before it is introduced into the oven than, for example, by a camera placed in the oven cavity.

If, for example, the control unit is designed as a tablet with a camera, information about food can be captured at a spatial position remote from the first kitchen appliance. This allows, for example, information to be detected on food arranged in a pantry, where the first kitchen appliance is a fixed kitchen appliance in a kitchen.

Furthermore, the information detected by the control unit can be taken into account in a second selection process. For example, several preparation instructions can be selected in a first selection process. Then, information detected by the control unit can be used as a search criterion to restrict the result of the first selection.

Alternatively or additionally, a detection means may be provided as an additional element of the system connected to the control unit, to the first kitchen appliance or to the second kitchen appliance via a communication connection. For example, an optical camera can take a picture of at least one food item, which is then transmitted to the control unit for evaluation. The information thus obtained on a property of a food can then be used to select a preparation instruction.

The control unit, the first kitchen appliance and the second kitchen appliance may be configured to display at least one preparation instruction and/or at least one piece of detected information. In this way, information relevant to the preparation of food can be displayed to a user on all elements of the system. This simplifies the use of the system.

### BRIEF DESCRIPTION OF THE DRAWINGS

In the following, preferred embodiments of the invention are explained in more detail using the attached drawing. The drawing shows in

FIG. 1 a first example of a system for the preparation of food in a schematic representation,

FIG. 2 Another example of a system for preparing food in a schematic representation,

FIG. 3 a first example of a preparation instruction with two preparation instruction variants in a tabular form, and

FIG. 4 Another example of a preparation instruction with two preparation instruction variants in a tabular form.

### DESCRIPTION OF THE INVENTION

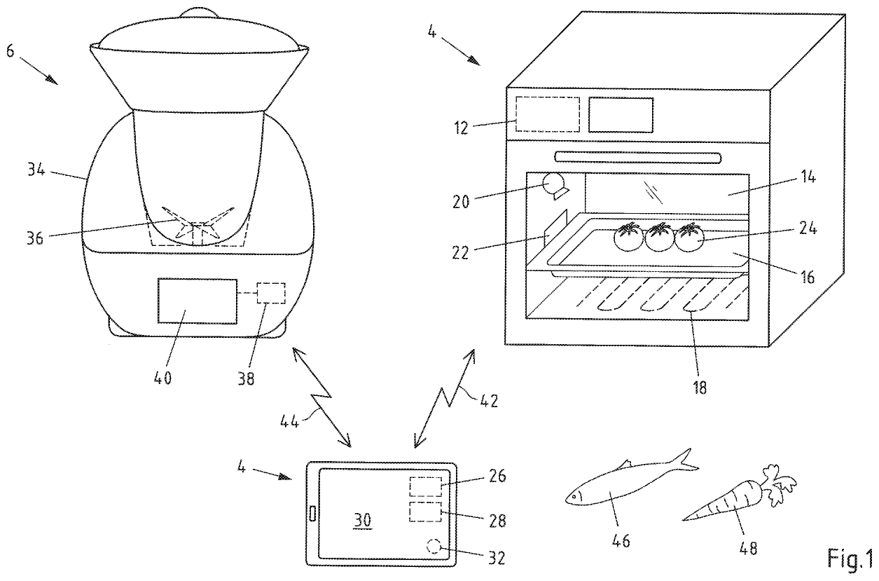

FIG. 1 shows a first example of a system 2 for preparing food in a schematic representation, wherein the system 2 comprises a first kitchen appliance 4 in the form of a baking oven, a second kitchen appliance 6 in the form of a cook mixer and a control unit 8 in the form of a tray.

The first kitchen appliance 4 has a housing 10, a control module 12, a storage volume 14, a food carrier 16 and a heating element 18. In addition, the first kitchen appliance 4 has detection means in the form of an optical camera 20 and a weighing module 22, each of which is configured to detect information about a type of food and information about a weight of food. The detection means 20, 22 are arranged in the storage volume 14.

The optical camera 20 is configured to detect an image of the interior of the storage volume 14, which is then evaluated by the control module 12 of the first kitchen appliance 4 to determine, for example, the presence of a type of food such as “tomato”.

The weighing module 22 is in contact with the food carrier 16 and is configured to detect a difference in weight between the weight of the food carrier 16 when empty and the weight of the food carrier 16 together with a food taken up on the food carrier 16, such as tomatoes 24 here. This way the weight of the food stored is determined.

The control unit 8 has a housing 25, a data memory 26, a microprocessor 28, a touch screen 30, which has the functions of a display device and the functions of a user interface, and a detection means 32 in the form of an optical camera.

The detection means 32 of the control unit 8 is configured to detect images, which are then analyzed to determine information about the food displayed. A corresponding algorithm is stored in the data memory 26 for this purpose, the execution of which on the microprocessor 28 causes at least one detected image to be evaluated.

The data memory 26 of control unit 8 contains a number of preparation instructions and an algorithm for comparing detected information with preparation instructions.

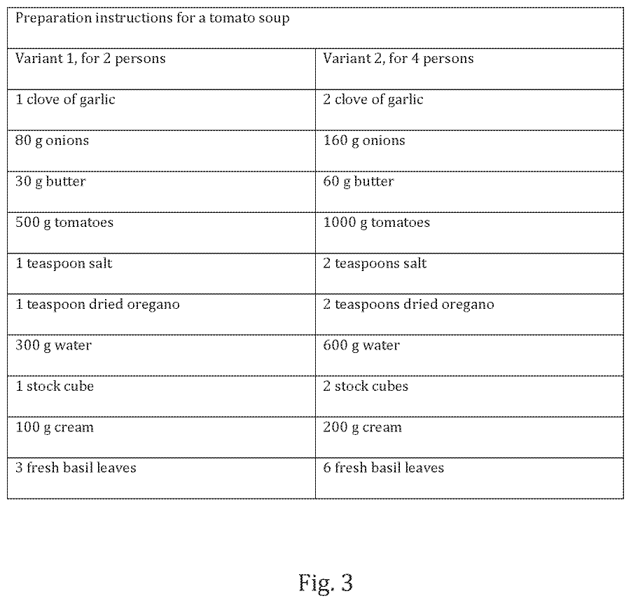

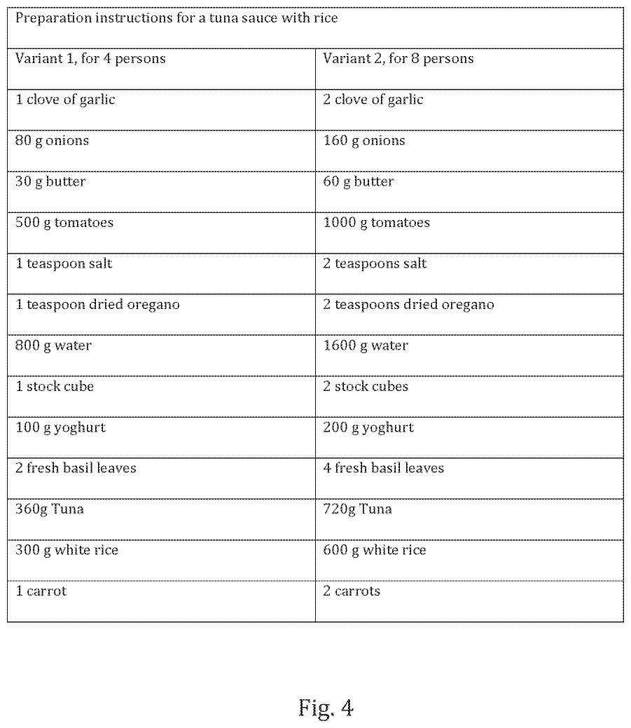

The stored preparation instructions each contain at least two preparation instruction variants with different indications on ingredient quantities. Two examples of indications on ingredient quantities given in a preparation instruction are given in FIGS. 3 and 4, whereby two preparation instruction variants are shown for each preparation instruction. The preparation instructions correspond to one preparation of tomato soup and one preparation of tuna sauce with rice. The first variant of the preparation instructions in the first column of the table in FIG. 3 is configured for a tomato soup for 2 persons. The first variant of the preparation instructions in the first column of the table in FIG. 4 is configured for a tuna soup with rice for 4 persons. There is a factor of 2 between the food quantity indications for the first variant and the indications for the second variant of a preparation instruction.

Furthermore, the preparation instructions contain preparation directives which correspond to different preparation processes on the first kitchen appliance 4 and on the second kitchen appliance 6.

The second kitchen appliance 6 has a housing 34, a shredding unit 36, a control module 38 and a display unit 40.

The control unit 8 is connected to the first kitchen appliance 4 via a first communication connection 42 and to the second kitchen appliance 6 via a second communication connection 44. Both communication connections 42, 44 are wireless and are based on WLAN technology. In addition, both communication connections enable 42, 44 for transmitting information in the direction starting from the control unit 8 and in the direction to the control unit 8.

There are foods 24, 46, 48 of different species: one tuna 46, one carrot 48 and three tomatoes 24.

In the following, a method for the preparation of food with the system 2 of FIG. 1 is exemplarily described.

First, the tomatoes 24 are placed on the food carrier 16 in the first kitchen appliance 4. An image is then taken by the optical camera 20, which is then evaluated by the control module 12 of the first kitchen appliance 4. The evaluation results in information about a type of food, in this case “tomato”. At the same time, the weighing module 22 detects information on the weight of a food, in this case the weight of the tomatoes 24, which corresponds to 500 grams.

The information detected, i.e. information on the type of food and information on the weight of the food, is then transmitted via the first communication connection 42 to control unit 8.

The algorithm is then executed on the microprocessor 28 of control unit 8 using the information detected as search criteria for comparison with preparation instruction's indications of the same kind. The comparison shows that the data for the first variants of each of the two preparation instructions of FIGS. 3 and 4 are closest to the information detected, since they contain data for 500 g of tomatoes. These preparation instruction variants are displayed by the touch screen 30 of the control unit 8.

Subsequently, a picture is taken and evaluated by the acquisition device 32 of the control unit 8, on which the tuna 46 and the carrot 48 are shown. After evaluation, the information on the presence of food of the food types “tuna” and “carrot” is obtained. This information is then compared with the indications of the two preparation instruction variants that have already been selected. The comparison shows that the preparation instruction variant for preparing a tuna sauce with 500 g of tomatoes is the closest to the information detected. The selected preparation instruction variant is then displayed on the touch screen 30 of control unit 8.

Subsequently, signals corresponding to the selected preparation instruction variant are transmitted via the second communication connection 44 to the second kitchen appliance 6 and displayed by its display device 40, so that preparation instructions of the selected preparation instruction variant can be carried out on the second kitchen appliance 6 during a corresponding preparation operation.

At the same time as the second kitchen appliance 6 carries out the preparation process, the first kitchen appliance 4 is preheated according to the preparation instructions of the selected preparation instruction variant.

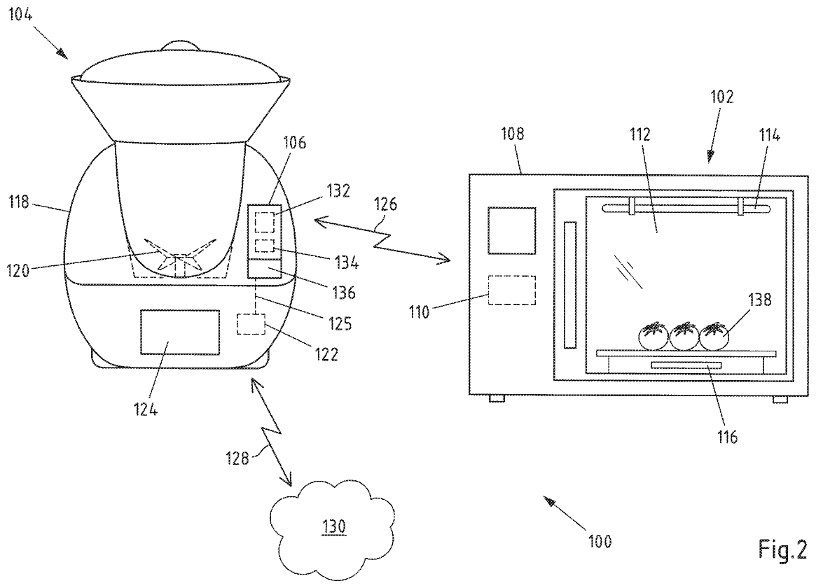

FIG. 2 shows another example of a System 100 for the preparation of food in a schematic representation. System 100 comprises a first kitchen appliance 102 in the form of a microwave oven, a second kitchen appliance 104 in the form of a cook mixer and a control unit 106, the control unit 106 being integrated into the second kitchen appliance 104.

The first kitchen appliance 102 has a housing 108, a control module 110, a storage volume 112 and a heating element 114, the control module 110 being designed to control the heating element 114. In addition, the first kitchen appliance 102 has detection means 116 in the form of a weighing module which is designed to detect information on a food weight and which is arranged in the storage volume 112.

The second kitchen appliance 104 has a housing 118, a mixing device 120, a control module 122 and a display device 124.

The control unit 106 is arranged in the housing 118 of the second kitchen appliance 104 and is connected to the second kitchen appliance 104 via a direct second communication connection 125. The control unit 106 is connected to the first kitchen appliance 102 via a first wireless communication connection 126 and to an external database 130 via a third wireless communication connection 128. Furthermore, the control unit 106 has a data memory 132, a microprocessor 134 and a user interface 136 for detecting user inputs.

Preparation instructions are stored in the external database 130. The control unit 106 is configured to retrieve preparation instructions from the external database 130 via the third communication connection 128 and, if necessary, temporarily store them in the data memory 132 of the control unit 106.

FIG. 2 shows food 138 in the form of tomatoes.

In the following, a procedure for preparing food using the System 100 of FIG. 2 is described as an example.

First, the food 138 is placed in the volume 112 and on the detection means 116 of the first kitchen appliance 102. Subsequently, the detection means 116 detects information on a food weight of 1000 g, which is then transmitted to the control unit 106 via the first communication connection 126. Then, through the user interface 136, the control unit 106 detects a first user input about a food type, in this case “tomato”, and a second user input about an exclusion of meat and fish products.

The control unit 106 then uses the first user input and the information detected by the first kitchen appliance 102 to generate a search criterion “1000 g tomatoes”. In a first selection process, the control unit 106 compares the search criterion with indications of preparation instructions concerning food types and food weights. The comparison results in the respective second preparation instruction variants of the preparation instructions shown above.

In a second selection process, the control unit 106 compares the second user input with information on ingredient types or with exclusion of meat and fish products with the preparation instructions variants selected in the first selection process. The comparison results in the second variant of the preparation instructions for preparing a tomato soup. This variant is displayed by the indicator 124 of the second kitchen appliance 104.

Subsequently, the user interface 136 detects a user input about a number of persons, in this case 3 persons. The control unit 106 uses this user input to calculate a new, third variant, whose indications correspond to the indications on ingredient quantities of the selected preparation instruction variant with a factor of 0.75. Then the new preparation instruction variant with the calculated ingredient quantities is displayed by the display 124 of the second kitchen appliance 104 and its preparation instructions are followed.

1. A system for preparing food,
with a first kitchen appliance,
with a second kitchen appliance and
with a control unit,
wherein the first kitchen appliance comprises at least one detection means for detecting at least one information about a property of a food,
wherein the control unit is connected to the first kitchen appliance via a first communication connection, and
wherein the control unit is connected to the second kitchen appliance via a second communication connection,
characterized
in that the control unit is configured to select at least one preparation instruction in dependence on the at least one information detected, and
in that the second kitchen appliance is configured to perform a preparation operation according to the at least one selected preparation instruction.

2. The system according to claim 1,
characterized
in that the preparation instruction has at least two preparation instruction variants with different quantity indications, and
in that the control unit is configured to select one of the preparation instruction variants in dependence on the at least one detected information.

3. The system according to claim 1,
characterized
in that the control unit is configured to determine a new preparation instruction variant on the basis of the selected preparation instruction and as a function of the at least one detected information.

4. The system according to claim 3,
characterized
in that the existing preparation instruction contain at least one indication about a quantity of ingredients, and
in that the new preparation instruction variant corresponds to a scaling of at least one indication.

5. The system according to claim 1,
characterized
in that the control unit is configured to select a preparation instruction as a function of a user input.

6. The system according to claim 1,
characterized
in that the control unit is connected via a third communication connection to an external database for preparation instructions, and
in that the control unit is configured to select the preparation instruction from the external database.

7. The system according to claim 1,
characterized
in that the first kitchen appliance is configured to perform at least one preparation operation according to the at least one selected preparation instruction.

8. The system according to claim 1,
characterized
in that the first kitchen appliance, the second kitchen appliance and/or the control unit is configured to display the at least one selected preparation instruction.

9. The system according to claim 1,
characterized
in that the control unit is integrated in the first kitchen appliance or in the second kitchen appliance.

10. The system according to claim 1,
characterized
in that the control unit has at least one detection means for detecting at least one piece of information about a property of a food and
in that the control unit is configured to select a preparation instruction in dependence on the at least one piece of information detected by the detection means of the control unit.

11. A method for preparing food,
in which at least one piece of information on a characteristic of a food is detected by a first kitchen appliance,
in which at least one preparation instruction is selected depending on the at least one piece of detected information, and
in which a preparation operation is performed by the first kitchen appliance according to the at least one selected preparation instruction.

12. The method according to claim 11,
in which a preparation instruction variant of a preparation instruction is selected depending on the at least one piece of information detected.

13. The method according to claim 11,
in which a new preparation instruction variant is determined on the basis of at least one existing preparation instruction variant and in dependence of the at least one piece of information detected.

14. The method according to claim 11,
in which the new preparation instruction variant is determined by scaling at least one indication on ingredient quantity specified by the selected preparation instruction.

15. The method according to claim 11,
in which at least one preparation instruction is selected depending on a user input.

16. The method according to claim 11,
in which at least one preparation instruction is selected from an external database.

17. The method according to claim 11,
in which at least one information about a property of a food is detected by the control unit and
in which a preparation instruction is selected in dependence on the at least one piece of information detected by the control unit.

18. The method according to claim 11,
in which at least one preparation operation is carried out by the first kitchen appliance in accordance with the at least one selected preparation instruction.

19. The method according to claim 11,
in which the at least one selected preparation instruction is displayed by another kitchen appliance.
